(19) United States
(12) Patent Application Publication
(10) Pub. No.: US 2023/0241479 A1
(43) Pub. Date: Aug. 3, 2023

(54) METHOD AND APPARATUS FOR INCENTIVIZING A MASS PARTICIPATION SPORT

(71) Applicant: TournPro Inc., Komoka (CA)

(72) Inventor: Scott HILL, Komoka (CA)

(21) Appl. No.: 18/158,227

(22) Filed: Jan. 23, 2023

Related U.S. Application Data
(60) Provisional application No. 63/267,257, filed on Jan. 28, 2022.

(51) Int. Cl. A63B 71/06

(52) U.S. Cl. CPC A63B 71/0616; A63B 2225/50

(57) ABSTRACT

Disclosed is a method and apparatus for determining and conveying a coupon amount for players and fans of a mass participation sport. A server receives an indication of a given sport team achieving a milestone (e.g. goal scored) during a game (e.g. road hockey), and increments a milestone count for the given sport team. According to an embodiment of the disclosure, the server determines at least one coupon amount (e.g. gift card at retailer) for players and fans of the given sport team based on the milestone count for the given sport team, and sends at least one message conveying the at least one coupon amount. In this way, the players and fans of the given sport team can become informed of the at least one coupon amount earned upon the milestone being achieved, thereby inciting excitement in their involvement with the given sport team by being “paid to play”.

### CROSS REFERENCE TO RELATED APPLICATION

This application claims the benefit of priority of U.S. Provisional Patent Application No. 63/267,257 filed on Jan. 28, 2022, which is hereby incorporated herein by reference in its entirety.

### FIELD OF THE DISCLOSURE

This disclosure relates to communication systems, and more particularly to integration and translation of communication systems for incentivizing a mass participation sport.

### BACKGROUND

A mass participation sport is a sports event or league for which prequalification is not required, and can involve numerous teams (e.g. thousands of teams) of amateur athletes over a large geographic area (e.g. Canada) for a given sport such as street hockey, street soccer, or street basketball, for example. In addition to numerous athletes (e.g. tens of thousands of amateur athletes), there can be numerous fans (e.g. hundreds of thousands of fans). However, unlike professional athletes, amateur athletes are not paid salaries, although they can attract sponsorship.

Sponsorship for a mass participation sport by business partners is possible, to provide advance funding infrastructure for staffing, marketing, and operation, and in return the sponsors receive rights to market directly to the players and fans of the sports event, with brand association, brand loyalty, and brand love generated as key considerations. Sponsorship does not normally provide for any prize money for winning teams, but rather in form of trophies, medals, t-shirts, or sometimes (rarely) in-kind product contributions. There is almost never prize money awarded in amateur sport, since by definition the sport would be considered professional.

Unfortunately, it has been observed that business partners have been reluctant to sponsor mass participation sports, because it is unclear to them whether advertising their brand is worth the cost of sponsorship. Conventional approaches to incentivise a mass participation sport leave much to be desired. It is desirable to improve upon the conventional approaches by employing technology to address or mitigate some or all of the aforementioned shortcomings.

Mass participation sports events usually take place in public spaces, such as streets, roadways, parking lots and highways. They may involve up to one mile or more of street closures. Transforming these public spaces into a sports venue, and then maintaining the spaces as the sports venue over a multi-day period involves support and engagement of a host municipality. Municipalities may not be quick to agree to host these types of events because, while the amount of disruption they cause is known, their benefit is very difficult to quantify. In addition, at first glance, these types of events might seem unnecessary. As a result, municipal support can be challenging to obtain. The municipality may require both charitable cause justification, and economic benefit justification, in order to agree to a multi-day public closure of such a large amount of roadway.

Unfortunately, there has been no convention to accurately 1) integrate charitable benefit and economic benefit through a sports event, 2) allow for measurable engagement of an unlimited number of charities to become beneficiaries of the event, and 3) measure, in real-time, the actual charitable impacts and economic benefits created directly by a mass participation sport. It is desirable to improve upon the conventional approaches by employing technology to address or mitigate some or all of the aforementioned shortcomings.

### SUMMARY OF THE DISCLOSURE

Disclosed is a method and apparatus for determining and conveying a coupon amount (e.g. financial benefit, in the form of retail credit) for players and fans of a mass participation sport. A server receives, over a network, an indication of a given sport team achieving a milestone (e.g. goal scored) during a game (e.g. road hockey), and increments a milestone count for the given sport team. According to an embodiment of the disclosure, the server determines at least one coupon amount (e.g. store credit at a retailer) for players and fans of the given sport team based on the milestone count for the given sport team, and sends, over the network, at least one message conveying the at least one coupon amount. In this way, the players and fans of the given sport team can become informed of the at least one coupon amount earned upon the milestone being achieved, thereby inciting excitement in their involvement with the given sport team because they are being “paid to play”.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a block diagram of an example communication system having a server coupled to a plurality of client computing devices via a network;

FIG. 2 is a flowchart of a method of determining and conveying a coupon amount for players and fans of a mass participation sport;

FIG. 3 is a flowchart of a method of incentivising a mass participation sport;

FIGS. 4A to 4I are screen shots of an example GUI (Graphic User Interface) for a sponsor to register; and

FIGS. 5A and 5B are flowcharts of methods of registration for stakeholders.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

### INTRODUCTION

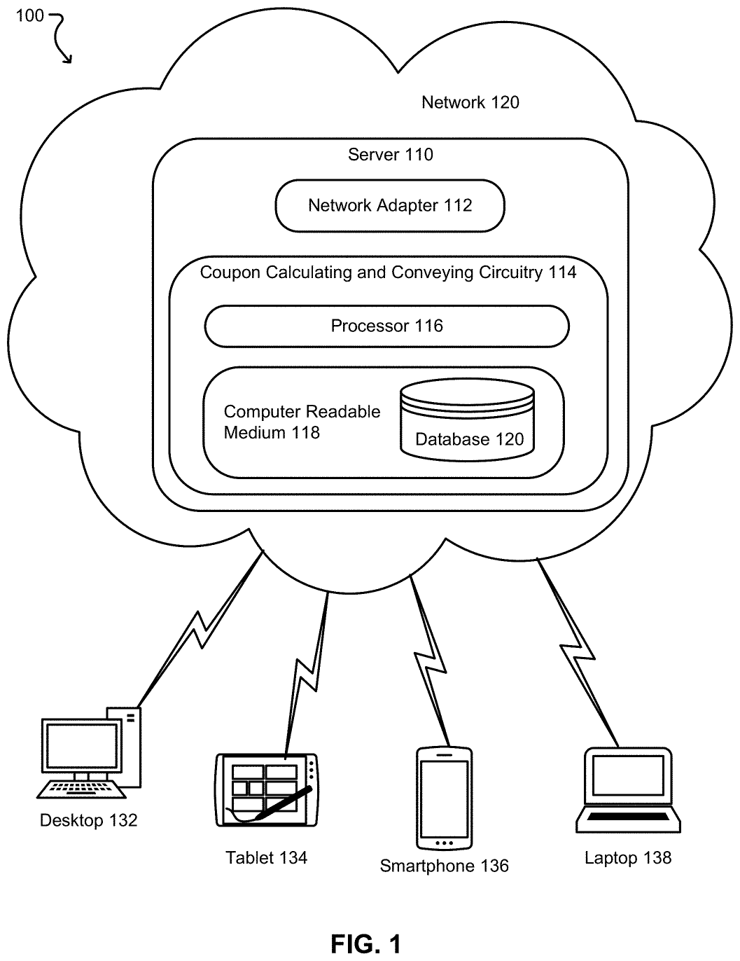

Referring first to FIG. 1, shown is a block diagram of an example communication system 100 having a server 110 coupled to a plurality of client computing devices 132,134,136,138 via a network 120. The communication system 100 can have other components as well, but these are not shown for simplicity. The server 110 has a network adapter 112 for communicating with the client computing devices 132,134,136,138 over the network 120. The server 110 also has coupon determining and conveying circuitry 114. The server 110 can have additional components, but these are not shown for simplicity.

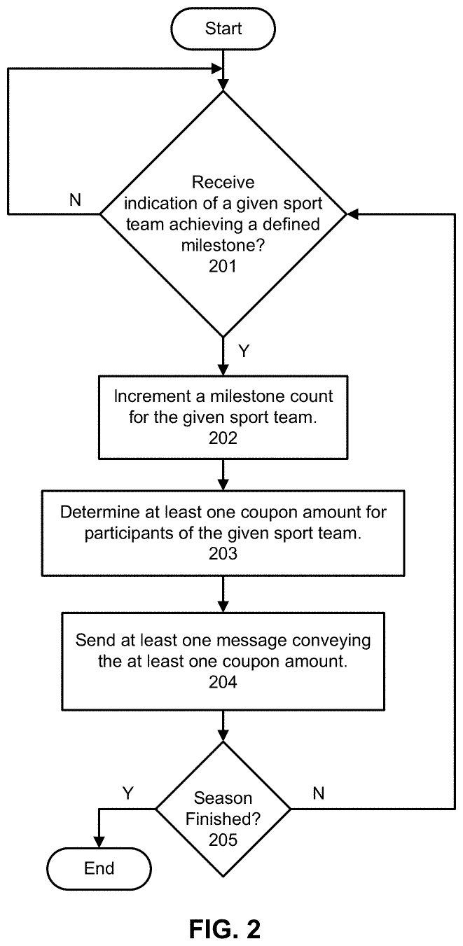

The coupon determining and conveying circuitry 114 of the server 110 operates to acquire information from at least some of the client computing devices 132,134,136,138, and to determine and convey at least one coupon amount (e.g. store credit at a retailer) to at least some of the client computing devices 132,134,136,138, based on the acquired information. Such operation will be described below with reference to FIG. 2, which is a flowchart of a method of determining and conveying a coupon amount for players and fans of a mass participation sport. Although the method of FIG. 2 is described below with reference to the server 110 in the communication system 100 shown in FIG. 1, it is to be understood that the method of FIG. 2 is applicable to other communication systems. In general, the method of FIG. 2 is applicable to the server 110 in any appropriately configured communication system.

If at step 201 the server 110 receives, over the network 120, an indication of a given sport team achieving a milestone (e.g. goal scored) during a game (e.g. road hockey), then at step 202 the server 110 increments a milestone count for the given sport team. The indication of the given sport team achieving the milestone can be received from one of the client computing devices 132,134,136,138. As a specific example, at each game of road hockey, there can be a referee who determines whenever a goal is scored and inputs this information into their smartphone, which in turn relays this information to the server 110. In this way, the server 110 can keep track of all goals scored by each sport team of the mass participation sport.

According to an embodiment of the disclosure, at step 203 the server 110 determines at least one coupon amount (e.g. store credit or gift card at a retailer) for players and fans of the given sport team based on the milestone count for the given sport team, and at step 204 the server 110 sends, over the network 120, at least one message conveying the at least one coupon amount. The at least one message can be sent to one or more of the client computing devices 132,134,136,138 used by the players and fans upon request or automatically using push technology. In some implementations, the at least one message includes a plurality of individual messages sent to the players and fans of the given sport team. In any event, the players and fans of the given sport team can become informed of the at least one coupon amount earned upon the milestone being achieved, thereby inciting excitement in their involvement with the given sport team because they are being “paid to play” via coupons redeemable with business partners.

In some implementations, steps 201 to 204 are repeated by the server 110 whenever the milestone is achieved by any sport team to enable the conveying of the at least one coupon amount for players and fans of the sport teams in real-time. Note that multiple games can be played simultaneously, and steps 201 to 204 can be repeated whenever any sport team involved in the multiple games achieves the milestone. In some implementations, steps 201 to 204 are repeated up until a season is finished at step 205. Depending on the season, this could occur over a course of serval days or several months for example.

In some implementations, the games of the mass participation sport are hosted in varying geographic locations (e.g. different cities, provinces, states, and/or countries), and the network 120 includes an Internet or other WAN (Wide Area Network) to enable the mass participation sport, such that step 201 involves receiving indications of milestones being achieved by the sport teams regardless of geographic location. Note that computer implementation is essential for enabling the mass participation sport over varying geographic locations in the manner described, especially to inform players and fans of the at least one coupon amount in real-time for games occurring in varying geographic locations.

There are many possibilities for the mass participation sport and the milestone. In some implementations, the mass participation sport is street hockey and the milestone is a goal being scored during a game. In some implementations, upon each goal being scored, the goal is reported back to the server 110, such that the milestone count can be incremented by one for each single goal being scored, and the determining and conveying of the at least one coupon amount can occur thereafter in real-time. In other implementations, after the game, a total number of goals scored by each team during the game is reported back to the server 110, such that the milestone count for each team can be incremented by the total number of goals being scored by the team, and the determining and conveying of the at least one coupon amount can occur after the game, or after the completion of all games in a given tournament.

It is to be understood that other mass participation sports are possible and are within the scope of the disclosure. For example, in other implementations, the mass participation sport is street soccer, street basketball, or ice hockey, for example, and the milestone is a goal being scored during a game. In other implementations, the mass participation sport is flag football and the milestone is a touchdown being made. In other implementations, the mass participation sport is softball and the milestone is a run being made. Regardless of the mass participation sport, reporting of milestones can occur during a game in real time as they occur, or following conclusion of the game as similarly described above. Other implementations are possible.

The client computing devices 132,134,136,138 interact with the server 110 in at least two ways: (1) sending indications of sport teams achieving milestones, in the case of client computing devices used by referees for example, and (2) receiving messages conveying sport-based, algorithm dependent coupon amounts, in the case of client computing devices used by players and fans for example. Note that the client computing devices used by referees may be mutually exclusive from the client computing devices used by players and fans, although it is certainly possible to have overlap, for example if a referee is a fan of a sport team.

There are many possibilities for the client computing devices 132,134,136,138. The client computing devices 132,134,136,138 can for example include a desktop computer 132, a tablet computer 134, a smartphone 136, a laptop 138, and/or any other appropriate client computing device. The client computing devices 132,134,136,138 can communicate with the server 110 using wireless connections as depicted and/or wired connections. Although only four client computing devices 132,134,136,138 are depicted, it is to be understood that there can be more or less than four computing devices, and typically there would be numerous client computing devices, for example thousands or even millions of client computing devices, for a mass participation sport.

There are many possibilities for the network 120. The network 120 can include several different networks even though such details are not shown for simplicity. For example, the network 120 can include a RAN (Radio Access Network) for communicating with wireless stations and the Internet for communicating with numerous other computing devices. The network 120 can have other components as well, but these details are not shown for simplicity.

There are many possibilities for the server 110. In some implementations, the server 100 includes a web server and the at least one message sent by the server 100 includes content for a web browser. Additionally, or alternatively, the server 100 can include an application server and the at least one message includes content for a mobile app. Other implementations are possible.

There are many possibilities for the network adapter 112 of the server 110. In some implementations, the network adapter 112 is a single network adapter 112. In other implementations, the network adapter 112 includes multiple network adapters, for example a first network adapter for communicating with the one or more client computing devices 132,134,136,138, and a second network adapter for communicating with other client computing devices, such as client computing devices utilized by a system administrator. Both wireless and wired network adapters are possible. Any suitable network adapter that can communicate via the network 120 is possible.

There are many possibilities for the coupon determining and conveying circuitry 114 of the server 110. In some implementations, the coupon determining and conveying circuitry 114 includes a processor 116 that executes software, which can stem from a computer readable medium 118. In some implementations, the computer readable medium 118 also has a database 120 for storing information identifying the sport teams as well as players and fans and a milestone count for each sport team. However, other implementations, besides software implementations, are possible and are within the scope of this disclosure. It is noted that other implementations can include additional or alternative hardware components, such as any appropriately configured FPGA (Field-Programmable Gate Array), ASIC (Application-Specific Integrated Circuit), and/or microcontroller, for example. More generally, the coupon determining and conveying circuitry 114 of the server 110 can be implemented with any suitable combination of hardware, software and/or firmware.

According to another embodiment of the disclosure, there is provided a non-transitory computer readable medium having recorded thereon statements and instructions that, when executed by the processor 116 of the server 110, implement a method as described herein. The non-transitory computer readable medium can be the computer readable medium 118 of the server 110 shown in FIG. 1, or some other non-transitory computer readable medium. The non-transitory computer readable medium can for example include an SSD (Solid State Drive), a hard disk drive, a CD (Compact Disc), a DVD (Digital Video Disc), a BD (Blu-ray Disc), a memory stick, or any appropriate combination thereof.

### Incentivising Mass Participation Sport

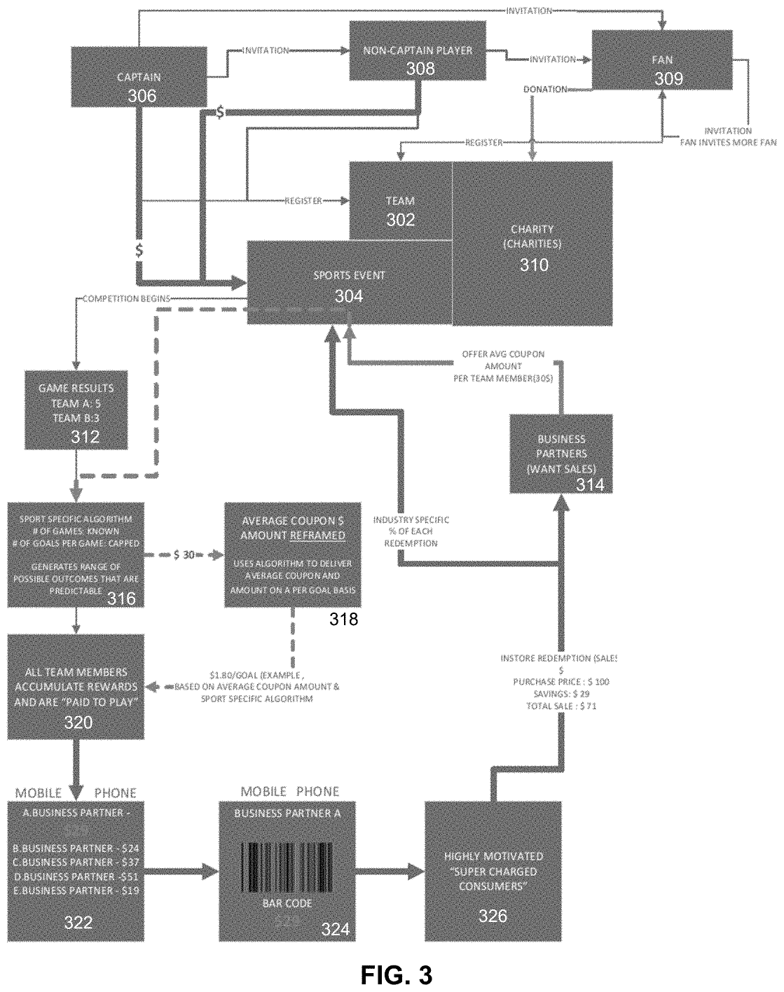

Referring now to FIG. 3, shown is a flowchart of a method of incentivising a mass participation sport. It is to be understood that the method is very specific and is provided merely as an example. Other methods of incentivising a mass participation sport are possible and are within the scope of the disclosure.

As an initial step, a team 302 is registered for a sport event 304 by a team captain 306. The team captain 306 can invite one or more non-captain players 308 to be part of the team 302, and in turn they can invite other non-captain players 308. Fans 309 (e.g. family and/or friends of the players) who do not play on the team 302 can be invited as well. In some implementations, the sport event 304 receives payment from participants, including the team captain 306, the non-captain players 308 and/or the fans. In some implementations, one or more charities 310 registered with the sport event 304 receive some or all of such payment. In some implementations, the players and fans select one of the charities 310 and an amount for payment/donation to that charity when registering. In some implementations, the payment/donation is optional but encouraged. The registration process is repeated for numerous different teams (e.g. thousands of teams), which may span across a large geographic region (e.g. across Canada) for the mass participation sport.

In some implementations, players become enrolled in the play for pay program when they invite a fan or fans and make their sport registration payment. In some implementations, fans become enrolled in the play for pay program when they make donations to one or more of the charities associated with the mass participation sports event. This creates a mechanism that allows municipalities and charities to measure the cause/social impact of mass participation events, and this invitation and enrollment process involving direct association with a mass participation sports event is part of some embodiments of disclosure.

Following registration of the teams, competition can proceed, in which numerous games involving the teams are played during a season of the mass participation sport. Game results 312 for each game are reported back over a network to a server of the sport event 304. Such reporting can occur upon each goal being scored, or upon completion of each game. Reporting can for example be performed by referees or scorekeepers at the games who each determine whenever a goal is scored and inputs this information into their smartphone or other computing device (e.g. tablet) which in turn relays this information to the server.

Prior to the competition, or possibly during the competition, and/or after the competition, business partners 314 can choose to offer an average coupon amount for all of the players and fans of the mass participation sport. For each business partner 314, the server receives over the network an indication of an average coupon amount to be awarded to the players and fans. In accordance with an embodiment of the disclosure, as shown at 318, for each business partner 314, the server determines a coupon amount per goal based on the average coupon amount for that business partner 314, an expected number of games, and an expected number of milestones per game. This enables all players and fans to be “paid to play” as shown at 320. In particular, for each team that scores a goal, all players and fans of that team receive a gift card amount with each business partner 314 that is incremented in accordance with the coupon amount per goal for that business partner 314. The determination and conveying of the gift card amount with each business partner 314 can be performed in real-time, thereby inciting excitement for all players and fans. Each player and fan can monitor and track the gift card amount for each business partner 314 through their smartphone or other client computing device as shown at 322.

As noted above, for each team that scores a goal, all players and fans of that team receive a gift card amount with each business partner 314 that is incremented in accordance with the coupon amount per goal for that business partner 314. It is contemplated that all players and fans of that team receive the exact same increment (i.e. players and fans of the team are incentivised in same way). However, other implementations are possible, such as players receiving a greater increment than fans.

At some point, such as after the tournament or after the season ends, or even during the tournament or season, a player or fan may choose to redeem a gift card at one of the business partners 313. In the illustrated example, the business partners 313 include business partner A through business partner E, and the gift card amount for business partner A is $29. In some implementations, to redeem a gift card, an identifying code (e.g. barcode as shown at 324) is produced for the player/fan. The business partner obtains that identifying code (e.g. using a scanning device) and reconciles with the server. In particular, upon a player or fan initiating a transaction with the business partner A, the server subtracts from the total transaction amount the gift card amount earned by the player/fan during the tournament or season as previously authorized by business partner A, such that the gift card amount has a minimum amount of zero and the player/fan pays any difference. For example, if the player/fan initiates a $100 transaction for purchase of a hockey stick, but has earned a $29 gift card through the mass participation sports event, the gift card amount is reduced down to zero and the player/fan pays the business partner $71 for the hockey stick. The player/fan is highly motivated, as shown at 326, because the hockey stick is purchased for only $71 instead of $100, which is a significant savings and tantamount to being “paid to play”. The business partner A can keep track of how much money is spent by players and fans, which could help them to decide on the average coupon amount for a next season of the mass participation sport.

Note that the $29 gift card, which is awarded only if a transaction is initiated by the player/fan, represents the business partner's “Sponsorship” of the mass participation sports event, in lieu of an up front rights fee. In some implementations, the business partner then pays to the organizer of the mass participation sports event an agreed upon percentage of the gift card amount (i.e. $29 in this instance) or the transaction amount (i.e. $100 in this instance), whichever is agreed upon, recognizing that the transaction would not have been created if the mass participation sports event had not created the incentive for the transaction. As an example, the business partner could pay 1% of the transaction amount, which is $1 in this instance, to the organizer of the mass participation sports event.

When describing what the business partner inputs, we can use the word “coupon” or “average coupon amount.” When describing the mass participation sports event we can describe that the event is “converting” the coupon into a gift card or store credit. It is noted that this entire process allows the business partner to offer an instrument that is a coupon (having properties such that the instrument costs them nothing to issue unless/until redeemed) while allowing the consumer (player/fan) to receive an instrument that functions as a gift card (i.e. store credit, without conditions). In some cases, the amount of the coupon/gift card cannot be determined until the sports event is completed, and that without the sports event, the likelihood of the coupon/gift card being redeemed is trivial (in a competitive digital marketing landscape) while the likelihood of the coupon/gift card being redeemed is highly probable when offered in conjunction with a mass participation sports event.)

In some implementations, a server helps to keep track of a number and value of gift cards awarded, redeemed, and remaining outstanding, in such a way that it may assist in deciding on the average coupon amount for the next season. The server can receive, over a network, a message conveying a commitment from a not-for-profit organization or charity to be a recipient of donations provided by fans of players in a mass participation sport event with donations conditional upon a number of goals achieved by a team in the mass participation sport event. Next, the server can track, in real-time over the network, a number and value of gift cards awarded, redeemed, and remaining outstanding as earned by players and fans of the mass participation sport event. Next, the server can measure, in real-time, a total economic impact created by the mass participation sport event based on the number and value of gift cards earned and redeemed as a result of player and fan participation in the mass participation sport event. In some implementations, such server is the server 110 shown in FIG. 2. In other implementations, such server is a separate server from the server 110 shown in FIG. 2.

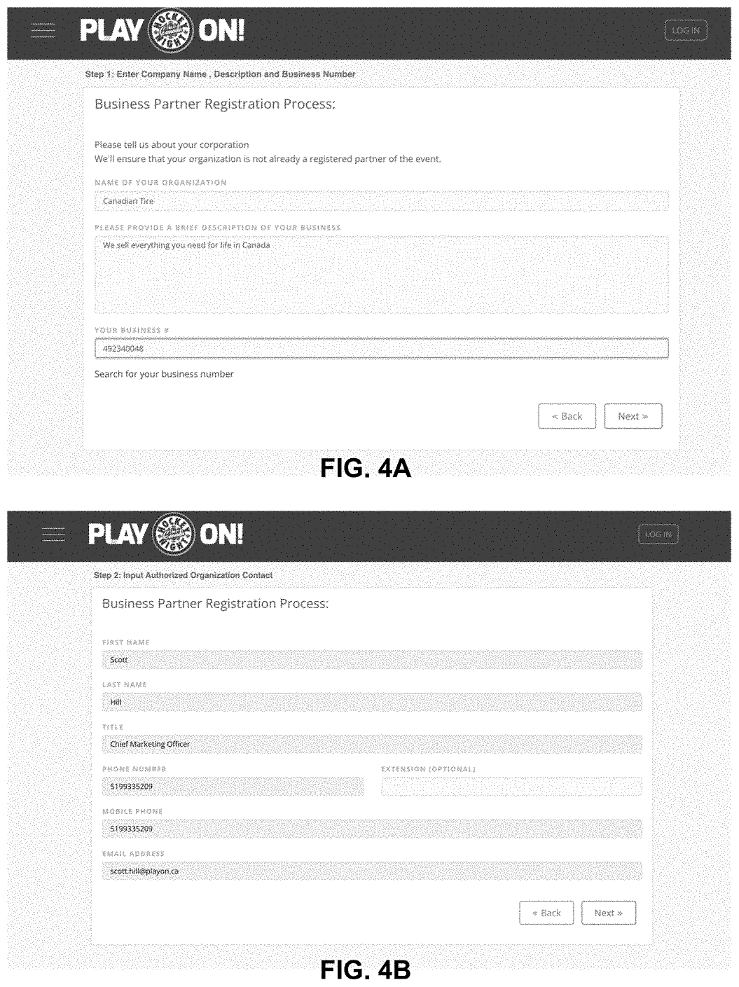

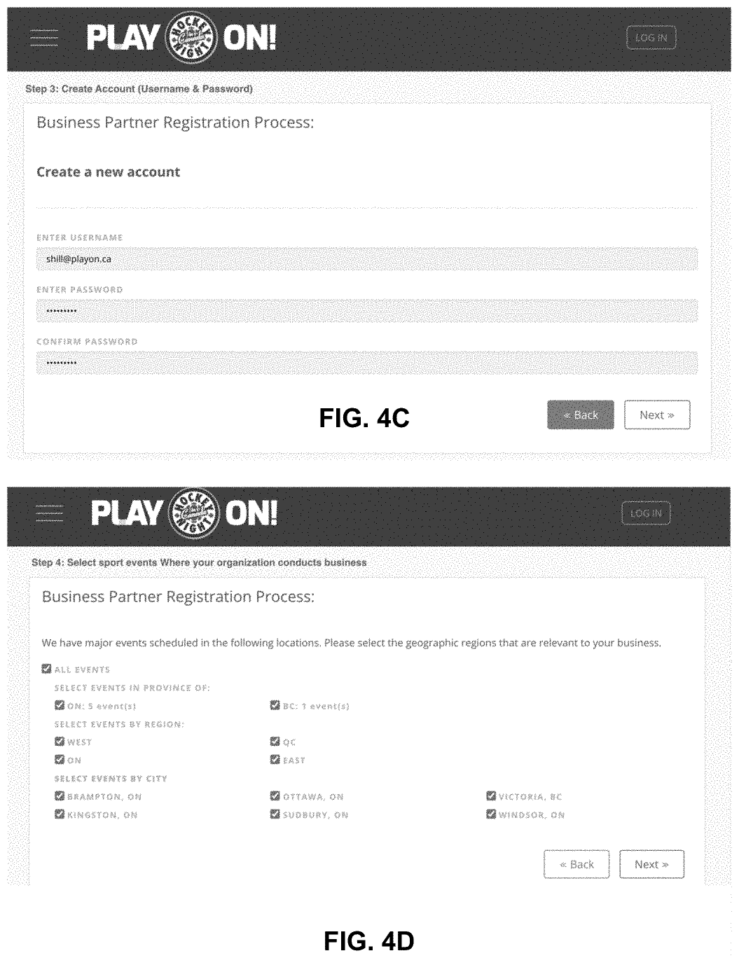

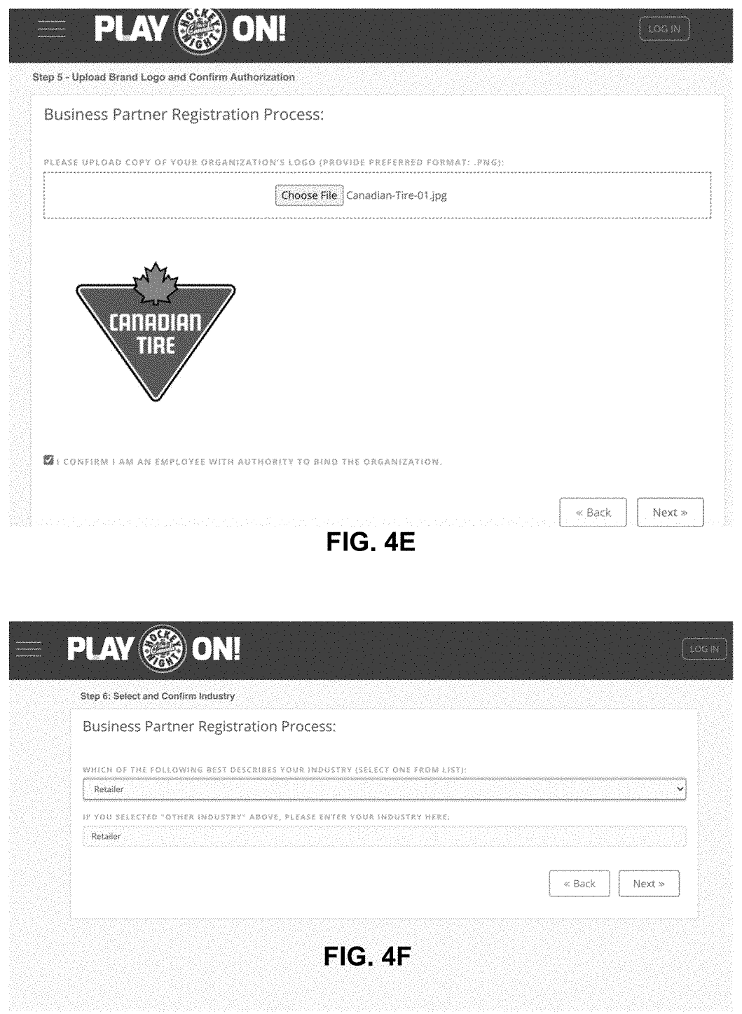

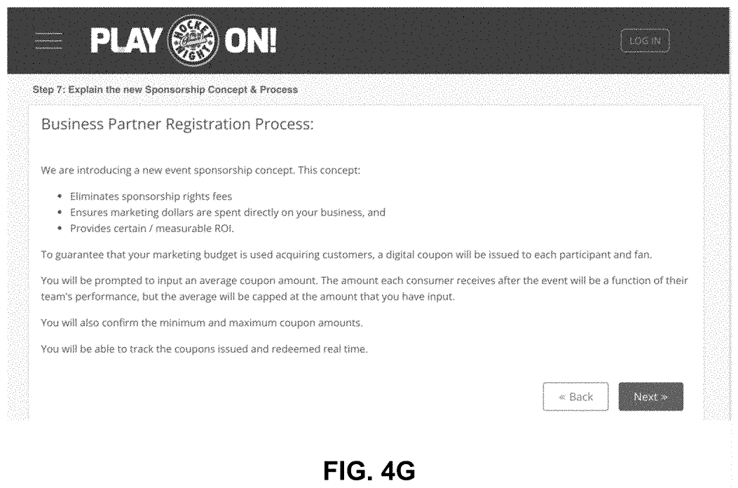

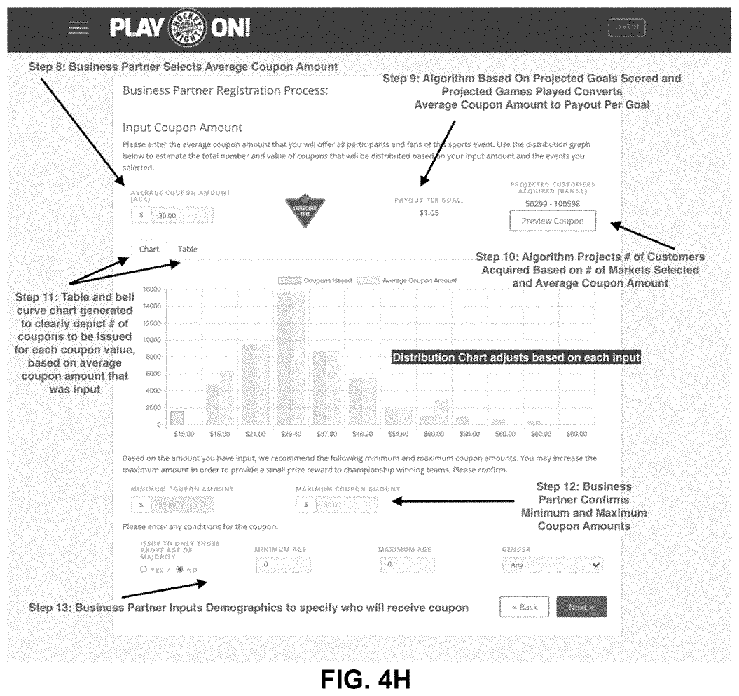

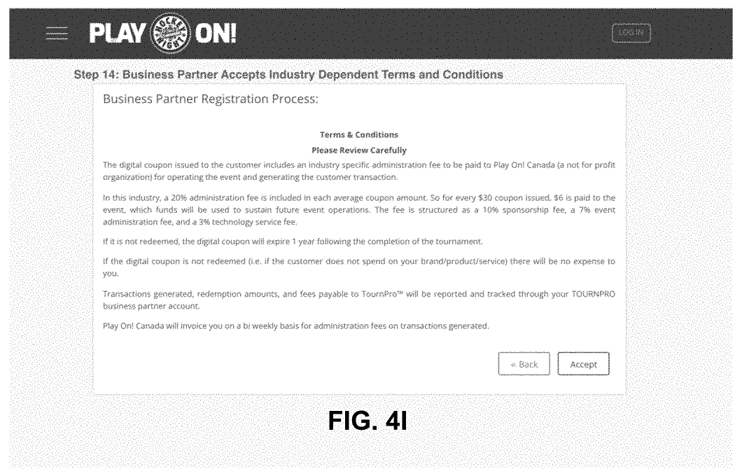

Referring now to FIGS. 4A to 4I, shown are screen shots of an example GUI (Graphic User Interface) of a registration process for business partners. The GUI can for example be a web-based GUI presented to business partners through a web page or a downloadable app provided by a server. It is to be understood that the GUI and the registration process are very specific and are provided merely as an example. Other GUIs and registration processes are possible and are within the scope of the disclosure. In the illustrated example, the registration process includes fourteen steps as listed below.
As a first step, as shown in FIG. 4A, a business partner enters a company name, a description and a business number. This information is relayed to the server, so that the server can create a new record for the business partner in a database, for example the database 120 of the server 110 shown in FIG. 1.
As a second step, as shown in FIG. 4B, the business partner inputs an authorized organization contact. This information is relayed to the server for storage in the database.
As a third step, as shown in FIG. 4C, the business partner creates an account by entering a username and a password. This information is relayed to the server for storage in the database.
As a fourth step, as shown in FIG. 4D, the business partner/specifies the sport events to be held in its relevant geographic regions (i.e. the business partner will participate in markets where their organization conducts business). This can enable to the business partner to target their advertising where it believes it may be most impactful. This information is relayed to the server for storage in the database.
As a fifth step, as shown in FIG. 4E, the business partner uploads a brand logo and confirms authorization. The server stores the brand logo in the database.
As a sixth step, as shown in FIG. 4F, the business partner selects and confirms an industry. This information is relayed to the server for storage in the database and may be used to determine the percentage of each transaction to be paid by the business partner to the sports event once a redemption transaction takes place.
As a seventh step, as shown in FIG. 4G, the GUI explains the new sponsorship concept and process. This is to inform the business partner.
As an eighth step, as shown in FIG. 4H, the business partner selects an average coupon amount for all players and fans of the sport events selected at the fourth step. This information is relayed to the server.
As a ninth step, as shown in FIG. 4H, a sport based algorithm implemented by the server determines a payout per goal (i.e. milestone) based on the average coupon amount selected in the eighth step, projected goals scored (i.e. milestones achieved), and projected games. The projected goals scored and projected games can be determined based on historical data for the sport events selected at the fourth step. Such historical data can be stored in the database or in another location that is accessible by the server.
As a tenth step, as shown in FIG. 4H, the algorithm projects a number of customers acquired based on the number of markets selected in the fourth step and the average coupon amount entered in the eighth step. This information can be useful for the business partner.
As an eleventh step, as shown in FIG. 4H, the GUI produces a table and/or a bell curve chart to clearly depict a number of coupons to be issued for each coupon value, based on the average coupon amount entered in the eighth step.
As an twelfth step, as shown in FIG. 4H, the business partner can confirm a minimum coupon amount and a maximum coupon amount. Depending on the minimum coupon amount and/or the maximum coupon amount, the algorithm may adjust the payout per goal to strive for the average coupon amount entered in the eighth step, and may adjust the table and/or the bell curve chart as well.
As a thirteenth step, as shown in FIG. 4H, the business partner can input demographics information to specify who will receive coupons. Coupons can be limited to players and fans based on gender, age, etc. For example, for a business partner that offers products principally to females, it is possible to limit coupons to only female players and fans. Depending on the demographics information, the algorithm may adjust the payout per goal to strive for the average coupon amount entered in the eighth step, and may adjust the table and/or the bell curve chart as well.
As an fourteenth step, as shown in FIG. 4I, the business partner agrees to industry dependent terms and conditions.

Upon successful completion of the registration process, the business partner is enrolled with the mass participation sport, and will play a key role in incentivising players and fans of the mass participation sport because players and fans are “paid to play” via coupons (converted through the process of the mass participation event into gift cards) redeemable with the business partner as described earlier. Meanwhile, the business partner will be advertised in the mass participation sport, for example based on the brand logo submitted in the firth step. Such advertising has little or no up-front cost, has predictable cost and value based on the number of customers acquired at the tenth step and subsequent redemption of coupons. Note that there may be many business partners that go through the registration process.

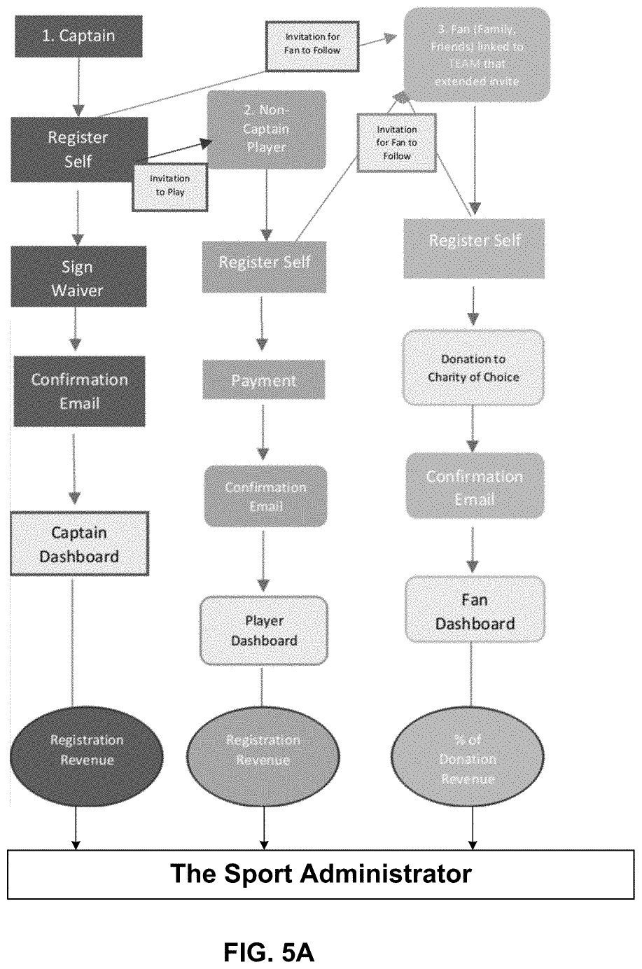

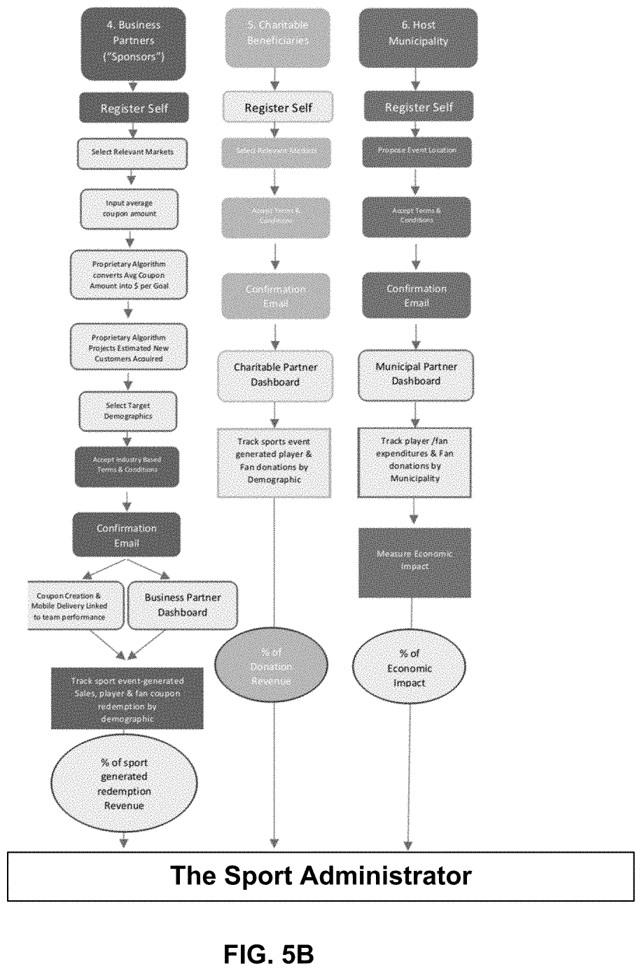

Referring now to FIGS. 5A and 5B, shown are flowcharts of methods of registration for stakeholders. It is to be understood that the registration process is very specific and is provided merely as an example. Other registration processes are possible and are within the scope of the disclosure. The flowcharts show how one platform can be used for six concurrent innovative & integrated stakeholder registration processes. FIG. 5A shows registration processes for 1) a team captain, 2) a non-captain player, and 3) a fan, as similarly described above for FIG. 3. FIG. 5B shows a registration process for 4) a business partner, as similarly described above for FIGS. 4A to 4I, and registration processes for 5) charitable beneficiaries and 6) Host municipalities as well. The registration processes are self-explanatory in light of the present disclosure as a whole.

Numerous modifications and variations of the present disclosure are possible in light of the above teachings. It is therefore to be understood that within the scope of the appended claims, the disclosure may be practised otherwise than as specifically described herein.

We claim:

1. A method of incentivizing a mass participation sport having a plurality of sport teams, comprising:
receiving, by a server over a network, an indication of a given sport team of the plurality of sport teams achieving a milestone during a game involving the given sport team and at least one other sport team of the plurality of sport teams;
incrementing, by the server, a milestone count for the given sport team based on the milestone being achieved;
determining, by the server, at least one coupon amount for players and fans of the given sport team based on the milestone count for the given sport team; and
sending, by the server over the network, at least one message conveying the at least one coupon amount.

2. The method of claim 1, wherein the receiving, the incrementing, the determining, and the sending steps are all repeated by the server whenever the milestone is achieved by any sport team of the plurality of sport teams to enable the conveying of the at least one coupon amount for players and fans of that sport team in real-time.

3. The method of claim 2, wherein games of the mass participation sport are hosted in varying geographic locations, and wherein the network comprises an Internet or other WAN (Wide Area Network) to facilitate the mass participation sport such that the receiving step involves receiving indications of milestones being achieved by the sport teams regardless of their geographic location.

4. The method of claim 1, wherein the mass participation sport is street hockey, street soccer, street basketball, or ice hockey, and wherein the milestone is a single goal being scored by the given team during the game, and wherein the milestone count is incremented by one for each single goal being scored.

5. The method of claim 1, wherein each sport team has players and fans, and the method further comprises:
receiving, by the server over the network, an indication of an average coupon amount to be awarded to the players and fans of the sport teams for a defined set of games involving the sport teams; and
determining, by the server, a coupon amount per milestone based on the average coupon amount, an expected number of games, and an expected number of milestones per game;
wherein the server determines, for each sport team, the at least one coupon amount for the players and fans of the sport team based on the milestone count for the sport team multiplied by the coupon amount per milestone.

6. The method of claim 5, wherein:
the at least one coupon amount comprises a plurality of coupon amounts, such that each coupon amount is associated with a sponsor; and
the method further comprises repeating for each sponsor (i) the receiving of the indication of the average coupon amount step, (ii) the determining of the coupon amount per milestone, and (iii) the determining of the coupon amount for the sponsor.

7. The method of claim 5, further comprising:
receiving, by the server over the network, an indication of a minimum coupon amount and an indication of a maximum coupon amount;
adjusting, by the server, the coupon amount per milestone based on the minimum coupon amount and/or the maximum coupon amount.

8. The method of claim 5, further comprising:
receiving, by the server over the network, demographics information limiting who will receive coupons;
adjusting, by the server, the coupon amount per milestone based on the demographics information.

9. The method of claim 5, wherein the at least one message comprises a plurality of individual messages sent to the players and fans of the given sport team.

10. The method of claim 5, wherein the server comprises a web server and the at least one message comprises content for a web browser.

11. The method of claim 5, wherein the server comprises an application server and the at least one message comprises content for a mobile app.

12. The method of claim 5, further comprising:
maintaining, by the server, a database identifying the plurality of sport teams as well as players and fans and a milestone count for each sport team, including the players and fans and the milestone count for the given sport team.

13. The method of claim 12, further comprising:
receiving, by the server over the network, player and fan information; and
inputting, by the server, the player and fan information in the database.

14. The method of claim 1, comprising:
receiving, by the server over a network, a message conveying a commitment from a not-for-profit organization or charity to be a recipient of donations provided by fans of players in a mass participation sport event with donations conditional upon a number of goals achieved by a team in the mass participation sport event;
tracking, in real-time by the server over the network, a number and value of gift cards awarded, redeemed, and remaining outstanding as earned by players and fans of the mass participation sport event;
measuring, in real-time via the server over the network, a total economic impact created by the mass participation sport event based on the number and value of gift cards earned and redeemed as a result of player and fan participation in the mass participation sport event.

15. A non-transitory computer readable medium having recorded thereon statements and instructions that, when executed by a processor of a server, configure the server to implement the method of claim 1.

16. A server configured to incentivize a mass participation sport having a plurality of sport teams, comprising:
a network adapter; and
coupon determining and conveying circuitry coupled to the network adapter and configured to implement the method of claim 1.

17. The server of claim 16, wherein:
the coupon determining and conveying circuitry comprises a processor; and
the server further comprises a non-transitory computer readable medium having recorded thereon statements and instructions that, when executed by the processor, configures the processor as the coupon determining and conveying circuitry.

18. A method for execution by a server, comprising:
receiving, by the server over a network, a message conveying a commitment from a not-for-profit organization or charity to be a recipient of donations provided by fans of players in a mass participation sport event with donations conditional upon a number of goals achieved by a team in the mass participation sport event;
tracking, in real-time by the server over the network, a number and value of gift cards awarded, redeemed, and remaining outstanding as earned by players and fans of the mass participation sport event;
measuring, in real-time by the server, a total economic impact created by the mass participation sport event based on the number and value of gift cards earned and redeemed as a result of player and fan participation in the mass participation sport event.
